(19) United States
(12) Patent Application Publication
(10) Pub. No.: US 2006/0244613 A1
(43) Pub. Date: Nov. 2, 2006

(54) Remote Controlled: locking wrist and/or ankle incapacitating electroschock stun bracelet for prisoner control

(76) Inventor: Steven Bradley Myers, Denver, CO (US)

Correspondence Address: STEVEN BRADLEY MYERS, 2890 SOUTH GOLDEN WAY, DENVER, CO, 80227, US

(21) Appl. No.: 11/117,029

(22) Filed: Apr. 29, 2005

(51) Int. Cl. G08B 23/00

(52) U.S. Cl. 340/573.4

(57) ABSTRACT

Remote Controled Elecroshock Locking Bracelet Stun Device, worn around the wrist or ankle, used for subduing a person by administering an electric shock. This is a non-lethal means of restraining a prisoner. It is not intended to kill. It is a weapon to be used by correctional officers, police officers, CIA, FBI, military personnel, court room prisoner control officers. This is not a device to be sold to the general public. This is not meant to cause permanent damage to a person, only to temporarily stun a person with electrical current at levals less than fatal, but enough to incapacitate them.

### SUMMARY OF INVENTION

In general the hardware of my invention consist of several subsystems, an incapacitating electroshock means, means for transmitting a coded on/off power activation signal on the electroshock bracelet, means for transmitting a coded shock activation signal on the electroshock bracelet, receiver means to receive the coded on/off power ativation signal from the transmitter, receiver means to receive the coded signal and activate the incapacitating electroshock from the transmitter and means of mounting the electroshock receiver effectively on the person(s) wrist and/or ankle by locking bracelet.

An incapacitating electroshock upon a prisoner(s) is delivered by an effective mechanism which produces momentary incapacitation without permanent harm.

The preferred embodiment includes electrical means for delivery of the incapacitating electroshock. In the preferred embodiment of my invention, the electroshock is a series of intermittent low amperage-high voltage pulsatile shocks, delivered from a prepackage locking wrist and/or ankle bracelet unit. My wrist and/or ankle bracelet is the same device, and fits on either position. My invention includes electrodes which when either placed on the skin or over clothing generates the incapacitating electroshock. This stun bracelet is far different from the stun pistols currently used.

Research has been found describing the detailed physiology of electrical impulses on the skin of sujects bodies very effective. Substantial practical experience with the stun pistol devices in police work has established that it is safe and effective for disabling unruly person(s) in arrest situations.

The pulsatile electroshock which the bracelet delivers works by momentarily confusing the body's nervous system. It is thought that the body's nervous system signals, which direct the musculoskeletal system are disrupted, and interfered with, and lacking coherence to produce normal control. The electroshock recipient's nervous system experiances a brief temporary failure. Recipient recovery takes approximately ten minutes.

### BRIEF DESCRIPTION OF INVENTION

THE REMOTE CONTROLED: LOCKING WRIST AND/OR ANKLE INCAPACITATING ELECTROSHOCK STUN BRACELET FOR PRISONER CONTROL apparatus of my invention includes means for delivering an incapacitating non-lethal electroshock to a prisoner. The means for delivering the incapacitating shock is incorporated into a locking bracelet worn on the prisoners wrist or ankle, above or below the clothing. The locking system of the bracelet makes it impossible for the prisoner to remove. Also incorporated into the bracelet is a radio receiver capable of receiving specific coded signals. The radio transmitter operates to turn the bracelet on and off. The radio transmitter operates to initiate the delivery of the incapacitating electroshock to the prisoner. The bracelet will have an indicator light that lights win power is on, it will also have an indicator light for low battery and recharging port. The radio transmitter is held by a guard, police officer or other authorized person within radio range. It may be a single channel device, or it may have multiple channels to enable its use in controlling a plurality of prisoners.

A session requiring the use of this invention would begin with the prisoner(s) after an arrest has taken place or in a conventional security status. The band would be placed on the prisoner by the police officer. The bracelet can be placed on the wrist or the ankle. If the detainee tries to escape or become hostile the officer would administer an incapacitating electroshock through the use of the radio transmitter. This invention can be worn on the police officers belt. This invention would be used in the same fashion for court rooms, correctional facilities, FBI, CIA, military personell, aircraft transports et. The bracelets and transmitters are on a coded transmission and recieving system that prevents activation of an improper bracelet.

### BACKGROUND OF INVENTION

The Remote Controled, Locking Wrist And/Or Ankle Incapacitating Stun Bracelet For Prisoner Control looks and is worn like an electronic home monitoring device. These may have a single bracelet transmitter or a transmitter that controls several bracelets individually or all at once. The prisoner is unable to remove or disable the bracelet. Should a prisoner become unruly or hostile the officer can administer by remote transmitter an incapacitating electroshock. The way the stun bracelet works is by interrupting the communication signal from the brain to the body. By delivering a very high voltage and a low amperage electrical charge, there is no long term damage.

Police, Guards, and others are being killed every year by their own weapons more than any other method. This is a control device that can not be taken away from the officer and used upon him or her self or others. This is a device that can be used when guards or others can not carry a weapon or have to control several prisoners alone or have a very large aggresive prisoner. It is important to have a device that can be used when subduing a prisoner, or during a prisoner transport, be it in prision, jails, court houses or aircraft. The bracelet is lightweight and carried by the officer on his/her belt and able to be applied to the prisoner with one hand, as handcuffs are. The transmitter is small and remains on the officers belt.

### BRIEF DESCRIPTION OF DRAWINGS

FIG. 1 is a frontal view of a radio control power on, power off, stimulation actuation transmitter unit for administering an incapacitating electroshock stun to a prisoner(s) or person(s) in accordance with my present invention. Number 1 represents the housing of said transmitter. Number 2 shows the anttena that transmitts radio signals to the receiver of wrist and/or ankle incapacitating electroshock stun bracelet. Number 3 is a button that when pressed, radios the receiver of the stun device to activate and administer an incapacitating shock. Number 4 is the transmit button for sending a radio signal to the stun device to remotely activate power turning the device on or off. Number 5 represents radio signal from transmitter to the receiver of the wrist and/or ankle bracelet receiver which turns the device on or off or to administer an elecroshock incapasitating stun. Number 6 represents the receiver of the wrist and/or ankle bracelet. Number 7 represents the wrist and/or ankle incapacitating electroshock stun bracelet.

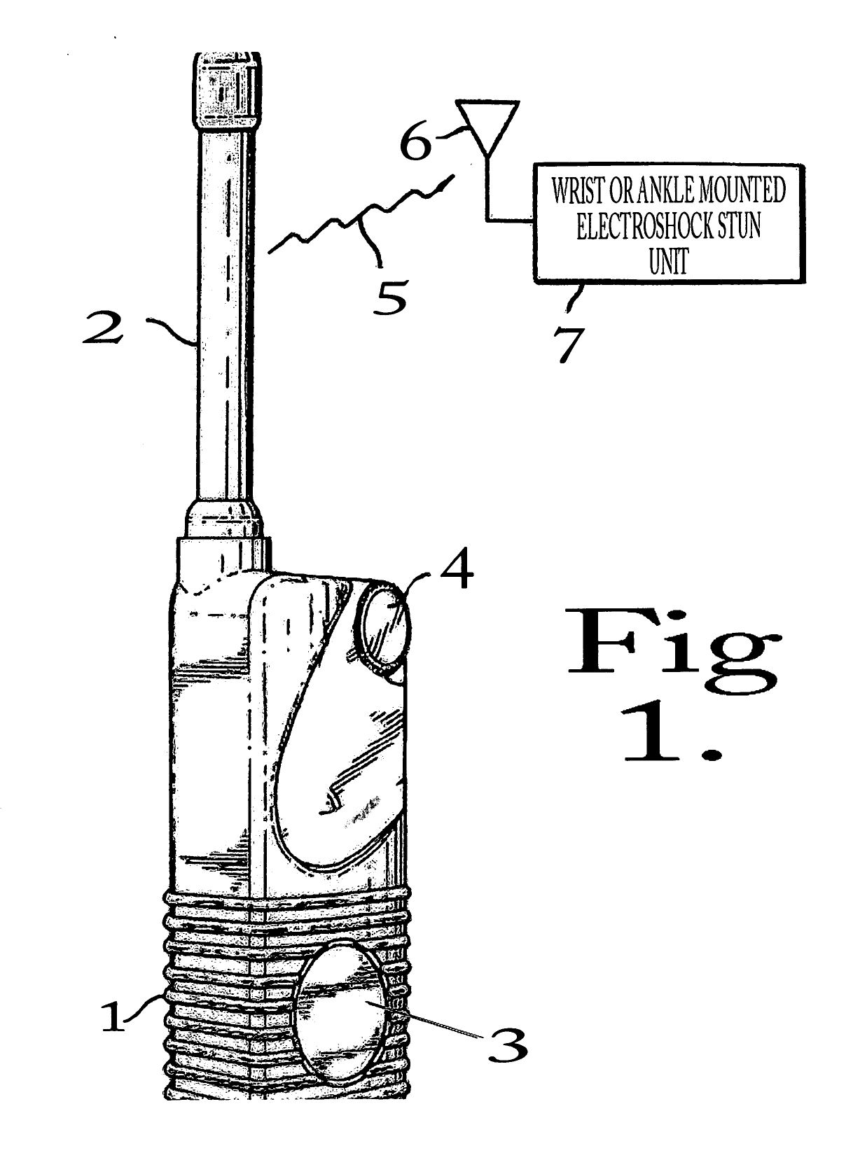

FIG. 2 shows the orientation of the wrist and/or ankle bracelet in the wrist position. Number 1 represents location and positioning of bracelet of my present invention.

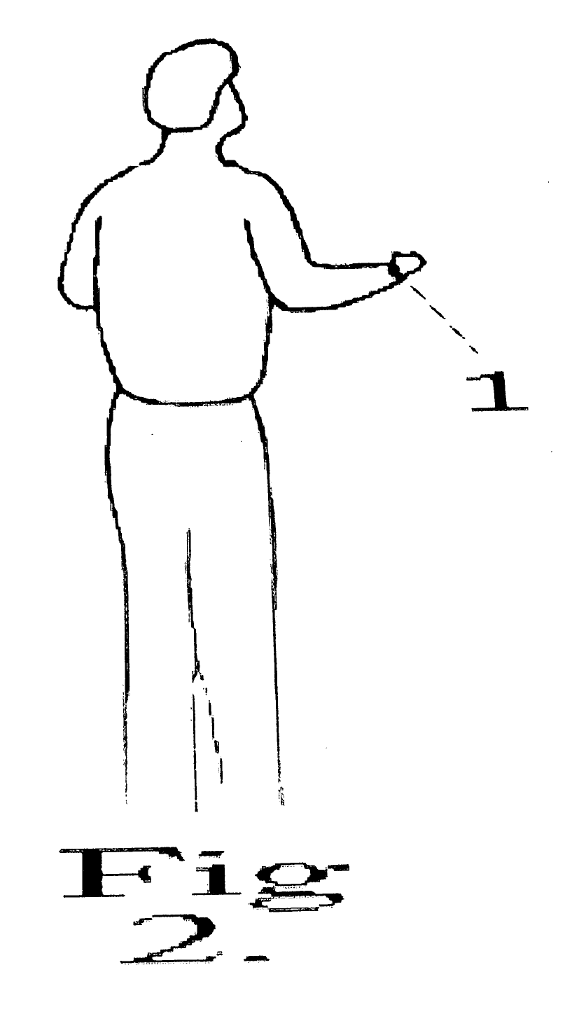

FIG. 3 number 1 shows the location and placement of the wrist and/or ankle incapacitating electroshock stun bracelet about the ankle area of my present invention.

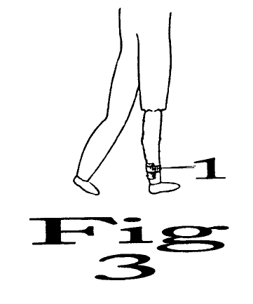

FIG. 4 is a graph of the incapacitating electroshock stun bracelet. Number 1 is the recharable battery that powers the incapacitating stun bracelet. Number 2 is a microprocceser for the receiver. Number 3 receives the transmissions from FIG. 1. Number 4 is the electroshock stun device that administers the incapacitating impact.

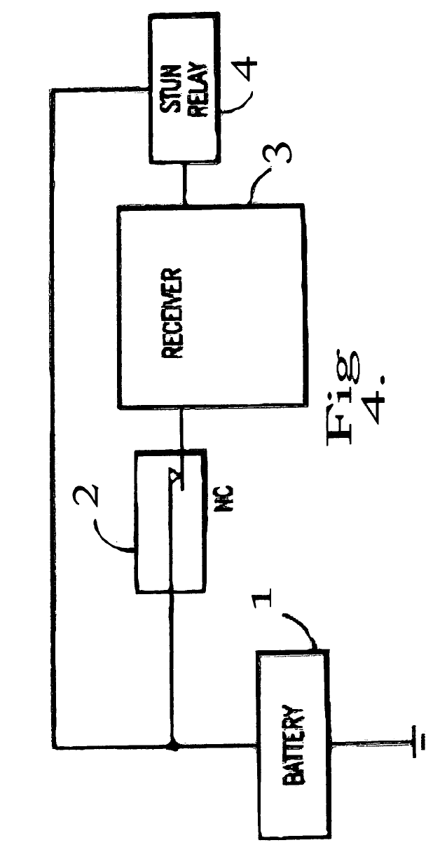

What is claimed:

1. Locking bracelet, placed on wrist or ankle for control of prisoner(s) to stop dangerous actions.

2. Bracelet of claim 1 is turned on by receiving a signal from remote control transmitter.

3. Bracelet of claim 1 is turned off by receiving a signal from remote transmitter.

4. Bracelet of claim 1 has a small indicator light that comes on when power is on.

5. Light of claim 4 turns off when power to bracelet of claim 1 is off.

6. Bracelet of claim 1 delivers a non-lethal incapacitating shock when receiving a signal from remote contol transmitter of claim 7.

7. Hand held transmitter used to remotely activate bracelet of claim 1.

8. Hand held transmitter of claim 7 is able to activate one or multiple bracelets of claim 1.

9. A recharging unit, used to recharge rechargable batteries of bracelet of claim 1.

10. Bracelet of claim 1 will include a low battery indicator light.

11. Bracelet of claim 1 is water resistant.

12. Bracelet of claim 1 has a locking band, this is only unlockable by authorized personell. Preventing prisoner(s) or person(s) from removing bracelet.

13. Bracelet of claim 1 can only be turned on or off by remote control transmitter of claim 7. Preventing prisoner(s) or person(s) from deactivating bracelet.
